(19) United States
(12) Patent Application Publication
(10) Pub. No.: US 2013/0231941 A1
(43) Pub. Date: Sep. 5, 2013

(54) SYSTEM AND METHOD FOR AUTOMATED OPTICAL DISPENSING

(71) Applicants: Mai Ngoc Pham, Elk Grove, CA (US); David Wallace Heglund, Gold River, CA (US); Michael Kenneth Mangelson, Cameron Park, CA (US)

(72) Inventors: Mai Ngoc Pham, Elk Grove, CA (US); David Wallace Heglund, Gold River, CA (US); Michael Kenneth Mangelson, Cameron Park, CA (US)

(73) Assignee: VISION SERVICE PLAN, Rancho Cordova, CA (US)

(21) Appl. No.: 13/410,513

(22) Filed: Mar. 2, 2012

(51) Int. Cl. G06Q 50/22

(52) U.S. Cl. 705/2

(57) ABSTRACT

A system and method for automated optical dispensing includes a mobile client device configured to receive a frame selection, collect measurements based on an image of a patient, and receive a lens selection. Based on the parameters of the frame selection the mobile client device determines a position of a prescription within the lens selection. The mobile client device also runs a compatibility verification to determine if the frame selection and the lens selection are compatible, and submits an order to a manufacturer for the frame selection and the lens selection when the frame selection and the lens selection are compatible. The mobile client device may also create and submit claims to an insurance clearing house for professional services and contact lens products and services when applicable.

### FIELD

The disclosure generally relates to eye care. More specifically, the disclosure relates to ordering optical devices.

### BACKGROUND

In general, eye care professionals (ECPs) prescribe prescriptions for spectacles, lenses, and/or contact lenses, fit frames, and recommend lens products for eye correction to improve vision and diagnose and treat various eye maladies. Currently, most ECPs record patient information, benefits information, measurements, and prescriptions by hand during examination of the patient and input such information into a computer.

Upon completion of an examination, the patient may be issued a prescription for eye correction. The patient typically selects one or more eyeglass frames and lenses or contact lenses. Currently, most ECPs physically provide the patient with a variety of frames to choose from. Typically, the patient tries on or tests multiple forms and styles of the frames and selects one or more of the frames that the patient desires. However, it can be difficult for patients with vision problems to see how they look in the frames, which can make it difficult for the patients to select a frame style. Additionally, while a patient may choose a frame style based purely on aesthetic considerations (i.e. it looks good) the patient's choice may not take into consideration proper fit, availability of appropriates lenses or lens coatings or types of lenses for the patient's particular situation.

When customized or personalized lenses are selected, for example, digital or freeform lenses, the ECPs may take measurements of vertex distance, frame wrap, pupillary distance, and pantoscopic tilt. These measurements are generally taken using manual devices such as, rulers, protractor type devices, pupilometers, distometers, and other manual devices or stand alone digital measurement devices.

Once the patient selects the frames and any measurements are taken, the ECPs place an order for the selected frames and lenses and submit a claim to the patient's insurance carrier, if any. At this point the patient generally leaves the ECP's office.

The order is typically sent to a manufacturer or laboratory that makes or produces the selected frames and lenses. However, not all frame and lens combinations can be produced. For example, some lenses cannot be integrated with certain frames. If the frame and lens combination selected by the patient cannot be produced, which may take days to find out, the patient will have to go back to the ECP's office and select a different frame and lens combination and a new order is submitted.

### SUMMARY

A system and method for automated optical dispensing disclosed herein provides an automated platform for the optical dispensing process. The system and method includes a mobile client device that is platform agnostic and can be integrated with an eye care professional's (ECP's) practice management interface (PMI) or practice management system/software (PMS). This allows the ECP to perform an integrated set of the day-to-day operations and the dispensing process via fully automated processes. The client device integrated with other processes as disclosed herein allows the ECP to input prescription information, check patient eligibility, obtain patient authorization, review benefits information, obtain measurements, display lens material and lens option choices to the patient, place orders, submit insurance claims, and perform additional tasks.

The client device may be implemented within and connected to a network of computer systems in a cloud computing infrastructure. This allows the client device to access a number of modules and databases. For example, the client device may communicate with, receive data from, transmit data to, and/or retrieve data from a number of frame suppliers and ophthalmic laboratories, claim processing centers, and insurance benefit providers. The client device may submit or transmit an insurance claim. An insurance claim is a completed health insurance claim form (CMS 1500 form) transmitted through a claim clearing house for insurance providers to seek payment for services. The submission of the insurance claim can also be in the form of a Health Insurance Portability and Accountability Act (HIPAA) 837 transaction. The client device may also transmit ophthalmic laboratory orders through the network of computer systems or cloud computing infrastructure and track the status of the order.

In an illustrative embodiment, the system includes a client device in communication with a computing infrastructure allowing the client device to access one or more modules or processes. The one or more modules include, but are not limited to, a frame module, a frame/lens cut-out module, a frame/lens compatibility module, a coating compatibility module, a measurement data module, a patient marketing module, a patient education module, and one or more associated databases. The client device and modules may also be in communication with one or more additional databases through the computing infrastructure, for example, one or more frame and/or lens parameter databases, and one or more coating parameter databases.

In an illustrative embodiment, the client device is a mobile client device configured to receive a frame selection, collect measurements based on an image of a patient, for example, via a measurement data module, and receive a lens selection. The mobile client device also communicates with one or more databases to obtain parameters of the frame selection and the lens selection. Based on the parameters of the frame selection the mobile client device determines a position of a prescription within the lens selection. The mobile client device runs a compatibility verification to determine if the frame selection and the lens selection are compatible. To run the compatibility verification, the mobile client device may access one or more of a frame/lens cut-out module, a frame/lens compatibility module, and a coating compatibility module. If the frame selection and the lens selection are not compatible, the mobile client device may prompt the patient to make a different frame selection. If the frame selection and the lens selection are compatible, the mobile client device submits an order to a manufacturer for the frame selection and the lens selection.

### BRIEF DESCRIPTION OF THE DRAWINGS

The systems and methods disclosed herein are illustrated in the figures of the accompanying drawings which are meant to be exemplary and not limiting, in which like references are intended to refer to like or corresponding parts, and in which:

FIG. 1 illustrates a system overview diagram of a system for automated optical dispensing according to the invention;

FIG. 2 illustrates a functional flow diagram of an overview of the system of FIG. 1;

FIG. 3 illustrates a functional block diagram for using the system for a patient consultation;

FIG. 4 illustrates a functional block diagram for using the system for evaluating and selecting frame options;

FIG. 5 illustrates a functional block diagram for using the system for evaluating frame and lens options;

FIG. 6 illustrates a functional block diagram of a frame/lens cut-out module of the system;

FIG. 7 illustrates an example of a lens that will not cut out properly for a frame;

FIG. 8 illustrates an example of a lens that will cut out properly for a frame;

FIG. 9A illustrates a functional flow diagram of a frame/lens compatibility module of the system;

FIG. 9B illustrates a functional block diagram of verification of frame and lens material and base curve compatibility as part of the frame/lens compatibility module; and

FIG. 10 illustrates a functional flow diagram of a coating compatibility module of the system.

### DETAILED DESCRIPTION

Detailed embodiments of a system and method for automated optical dispensing are disclosed herein, however, it is to be understood that the disclosed embodiments are merely exemplary of the systems and methods, which may be embodied in various forms. Therefore, specific functional details disclosed herein are not to be interpreted as limiting, but merely as a basis for the claims and as a representative basis for teaching one skilled in the art to variously employ the systems and methods disclosed herein.

Generally, the systems and methods disclosed herein include and are implemented within a computer system, network of computer systems, one or more mobile devices, or cloud computing infrastructure having one or more databases and other storage apparatuses, servers, computer networks, and additional components, for example, processors, modems, terminals and displays, computer-readable media, algorithms, modules, and other computer-related components. The computer systems and/or computing infrastructure are especially configured, programmed, and adapted to perform the functions and processes of the systems and methods as disclosed herein.

Communications between components in the systems and methods disclosed herein may be unidirectional or bidirectional electronic communication through a wired or wireless configuration or network. For example, one component may be wired or networked directly, indirectly, through a third party intermediary, wirelessly, over the Internet, or otherwise with another component to enable communication between the components.

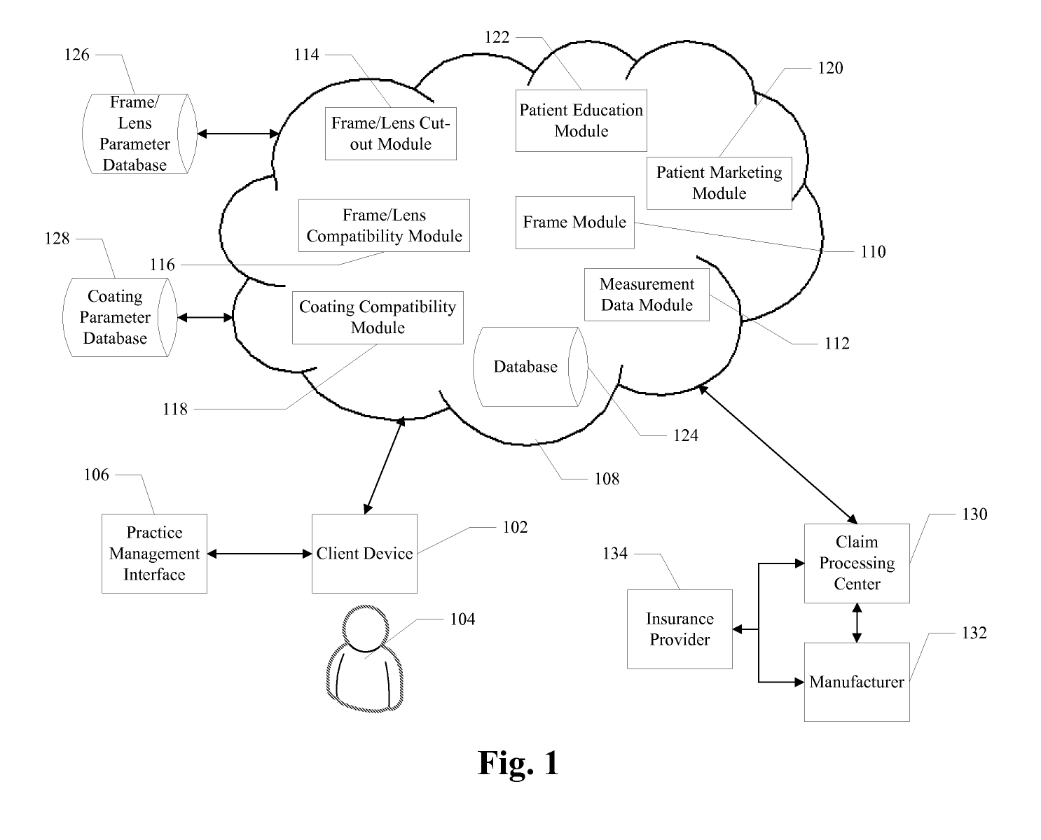

An overview of the system and method for automated optical dispensing according to an illustrative embodiment is described with reference to FIG. 1. As illustrated in FIG. 1, the system includes at least one client device 102 configured to receive or collect input data from at least one user 104, which may be a patient or an eye care professional (ECP), for example, an optometrist, an optician, an assistant, or other eye care technician. The client device 102 may be in communication with a practice management interface (PMI) or practice management system/software (PMS) 106.

In general, the PMI/PMS 106 is a system or software used by ECPs that deals with the day-to-day operations of the ECPs' practice, for example, Compulink by Compulink Business Systems, Inc. of Westlake Village, Calif., MaximEyes by First Insight-Optometry of Hillsboro, OR, OfficeMate by Eyefinity, Inc. of Rancho Cordova, Calif., or AcuityLogic by Eyefinity, Inc. of Rancho Cordova, Calif., and other PMIs/PMSs of the type. The PMI 106 receives data and stores data in a local storage database or a remote storage database. Generally, the PMI 106 allows the ECPs to input and store patient demographic information, patient history information, patient prescription information, patient orders, schedule appointments, maintain lists of insurance providers, perform billing tasks, and generate reports.

In an illustrative embodiment, the client device 102 is integrated into the PMI 106. In this illustrative embodiment, the client device 102 is configured to collect data, receive data, and transmit data within the PMI 106. The client device 102 allows the ECPs to perform the day-to-day operations of the ECPs' practice via the client device 102. In another illustrative embodiment, the client device 102 is a PMI and replaces the PMI 106 in whole or in part.

In an illustrative embodiment, the client device 102 communicates with, receives data from, and transmits data to a computing infrastructure 108. In general, the computing infrastructure 108 provides computing/processing resources, software, data access, and storage resources without requiring the user or client to be familiar with the location and other details of the computing infrastructure.

The computing infrastructure 108 or computer network may include one or more modules accessible by the client device 102, for example, a frame module 110, a measurement data module 112, a frame/lens cut-out module 114, a frame/lens compatibility module 116, a coating compatibility module 118, a patient marketing module 120, a patient education module 122, and one or more databases 124. The computing infrastructure 108, one or more of the modules 110-122, and the client device 102 are also in communication with and configured to receive, collect, and transmit data to and from one or more databases, for example one or more frame and/or lens parameter databases 126 and one or more coating parameter databases 128.

In an illustrative embodiment, the client device 102 includes one or more optical and image acquisition technologies, for example, one or more digital cameras that may be used to collect one or more images, video, or take one or more photographs of the patient.

The patient may select and try on one or more optical or corrective devices, for example different frame styles, and one or more images of the patient may be collected or taken of the patient by the client device 102 or image acquisition technology associated with the client device. The frame module 110 receives the image(s) and stores the image(s) in the database(s) 124. The client device 102 may retrieve the image(s) from the database(s) 124 via the frame module 110 and display the image(s) on the client device 102 for the patient or user 104 to view. The client device 102 may display the image(s) one at a time, two at a time, or more than two at a time. This allows the patient or user 104 to view one or multiple images of the patient wearing different frame styles at the same time and compare how each frame style looks on the patient.

The frame module 110 also allows the user 104 to input or select one or more frame styles into or on the client device 102 and store the selection(s) in the database(s) 124. The frame module 110 stores frame selection data and images in association with the patient allowing the data and images to be retrieved by the client device 102.

In an illustrative embodiment, the measurement data module 112 receives the one or more images or one or more photographs of the patient with or without the patient wearing a selected frame. The measurement data module 112 receives the image(s) from the client device 102, or retrieves the image(s) from the database(s) 124. The measurement data module 112 is configured to calculate or determine one or more measurements from the image(s) using, for example, facial recognition technology, video analysis, image processing, object recognition, three-dimensional (3-D) graphics, digital measuring technologies that utilize a sensor attached to the patient's frames, and/or other digital measuring technologies of the type. The measurements calculated or determined by the measurement data module 112 may include, but are not limited to, the patient facial measurements, pupillary distance (PD), vertex, pantoscopic tilt (panto), frame wrap, segment height, optical center height, facial shape, and other measurements of the type.

In another illustrative embodiment, the ECP may manually measure or use a digital measuring device or system to obtain one or more of the pupillary distance (PD), vertex, pantoscopic tilt (panto), frame wrap, segment height, optical center height, and other measurements of the type and manually or automatically input one or more of the measurements into the client device 102. The client device 102 may also be integrated with the digital measuring device or system allowing the measurements to be automatically transmitted to and received by the client device 102 from the digital measuring device or system. The client device 102 may then transmit the measurements to the measurement data module 112, and/or store the measurements in the database(s) 124. In an illustrative embodiment, the digital measuring device may be a stand alone device, for example, a digital measuring device that uses digital images of the patient with a sensor attached to the patient's frames. One example of such a digital measuring device is Optikam by Optikam Tech. Inc. of Montreal, OC, Canada.

The measurements obtained may be used to ensure that the patient's frame fits the patient correctly and that the patient's prescription is placed within the lenses correctly based on the shape of the frames and lenses.

The frame/lens cut-out module 114 communicates with the frame and/or lens parameter database(s) 126. The frame and/or lens parameter database(s) 126 includes information on a number of frames and lenses, for example, but not limited to, lens cut-out charts, lens material, lens material appropriate for certain prescriptions, lens shape, lens diameter, lens thickness, frame size, frame identifier, frame color, frame eye size, frame bridge size, temple length, frame type, frame edge type, frame box measurements, frame circumference, frame base curve, frame shape, and other information of the type. In an illustrative embodiment, the frame and/or lens parameter database(s) 126 may be a database(s) provided by, for example, Vision Service Plan of Sacramento, Calif.; Jobson Healthcare Information (JHI) of New York, N.Y.; Digital Vision Incorporated (DVI) of Portland, Oreg.; and other databases of the type.

In an illustrative embodiment, the client device 102 is configured to receive a prescription, lens type, and/or frame selection from the user 104 and access the frame/lens cut-out module 114. The lens type may be, for example, a stock lens, a progressive lens, a safety lens, a prescription lens, a single vision lens, a bifocal lens, a trifocal lens, a freeform lens, and other lens types. The frame/lens cut-out module 114 receives the prescription, lens type, and/or frame selection and communicates with and retrieves data from the frame and/or lens parameter database(s) 126. The frame/lens cut-out module 114 uses the data to determine the proper lens cut-out and whether the frame selection has a size that falls outside of the lens diameter. The frame/lens cut-out module 114 ensures the proper lens cut-out.

In an illustrative embodiment, the client device 102 accesses the frame/lens compatibility module 116. The frame/lens compatibility module 116 receives the prescription, lens type, and frame selection and communicates with and retrieves data from the frame and/or lens parameter database(s) 126. The frame/lens compatibility module 116 uses the data in the frame and/or lens parameter database(s) 126 to determine whether the prescription, lens type, and frame selection are compatible. The frame/lens compatibility module 116 then transmits the compatibility determination to the client device 102. If the prescription, lens type, and frame selection are not compatible, the client device 102 may prompt the user 104 to make a different frame selection, and the process may be repeated to ensure the prescription, lens type, and frame selection are compatible.

In an illustrative embodiment, the user 104 or patient may choose to include a coating on the patient's lenses, for example, a tint, an anti-reflective coating, or other coating known in the art. The client device 102 receives the patient's coating choice(s) and accesses coating compatibility module 118. The coating compatibility module 118 receives the coating choice(s) and one or more of the prescription, lens type, and lens material and communicates with or retrieves data from the coating parameter database(s) 128. The coating parameter database(s) 128 includes information related to lenses and coatings, for example, coating category, coating manufacturer, lens material, material description, lens style, focal type, coating code, and other information of the type.

The coating compatibility module 118 uses the data in the coating parameter database(s) 128 to determine whether the coating choice and the patient's lenses are compatible. If the coating choice and the patient's lenses are not compatible, the client device 102 may prompt the user 104 to make a different coating choice, and the process may be repeated to ensure the patient's lenses and coating choice are compatible. In an illustrative embodiment, the coating compatibility module 118 only presents coatings to the user 104, via the client device 102, that are compatible with the patient's lens material by accessing a coating check table that indicates compatible coating for various lenses contained within the database(s) 124 and/or the coating parameter database(s) 128.

In an illustrative embodiment, the client device 102 accesses the patient marketing module 120. The patient marketing module 120 provides the client device 102 with marketing material that can be displayed on the client device 102 and presented to the patient or user 104. The marketing material may include advertisements, brochures, frames that can be purchased, and other material of the type. In an illustrative embodiment, the patient marketing module 120 provides an interactive shopping experience to the patient via the client device 102 that allows the patient to browse various types of eyewear, frames, lenses, sunglasses, safety glasses, sports eyewear, and other types eyewear and eye or vision related products.

In an illustrative embodiment, the client device 102 accesses the patient education module 122. The patient education module 122 provides the client device 102 with a variety of information that may be displayed on the client device 102 and presented to the patient or user 104. The information that may be displayed may include, but is not limited to, news, educational information, information related to vision problems and medical conditions, information related to lens options, coating options, contact lens options, frame options, and other information related to eye care.

The database(s) 124 may store all or part of the data, determinations, and other information communicated between and generated by the client device 102 and all of the modules, including the frame module 110, the frame/lens cut-out module 114, the frame/lens compatibility module 116, the coating compatibility module 118, the measurement data module 112, the patient marketing module 120, the patient education module 122, and other modules within the computing infrastructure 108.

In an illustrative embodiment, the client device 102 may communicate with one or more claim processing centers 130 via the computing infrastructure 108 to submit insurance claims for eye examinations, prescriptions, frames, contact lenses and spectacle lenses, place orders for frames and prescription lenses, and submit billing information. The submission of the insurance claim may be a completed health insurance claim form (CMS 1500 form) transmitted through a claim clearing house or claim processing center(s) 130 for insurance providers to seek payment for services. The submission of the insurance claim can also be in the form of a Health Insurance Portability and Accountability Act (HIPAA) 837 transaction. In general, the claim processing center(s) 130 receive the claim and order, and process the claims and order based on the patient's insurance benefits package, if any. The claim processing center(s) 130 may also transmit the orders to one or more manufacturers or laboratories 132 that produces the frames and lenses to fulfill the order(s). In another illustrative embodiment, the client device 102 may communicate orders directly to the manufacturer or laboratory 132.

The claim processing center(s) 130 and/or the manufacturer or laboratory 132 may also be in communication with one or more insurance providers 134. This allows the claim processing center(s) 130 and/or the manufacturer or laboratory 132 to receive the insurance benefit information related to the claim or order. The client device 102 may also be able to access patient insurance benefit information via the claim processing center(s) 130 and insurance provider(s) 134.

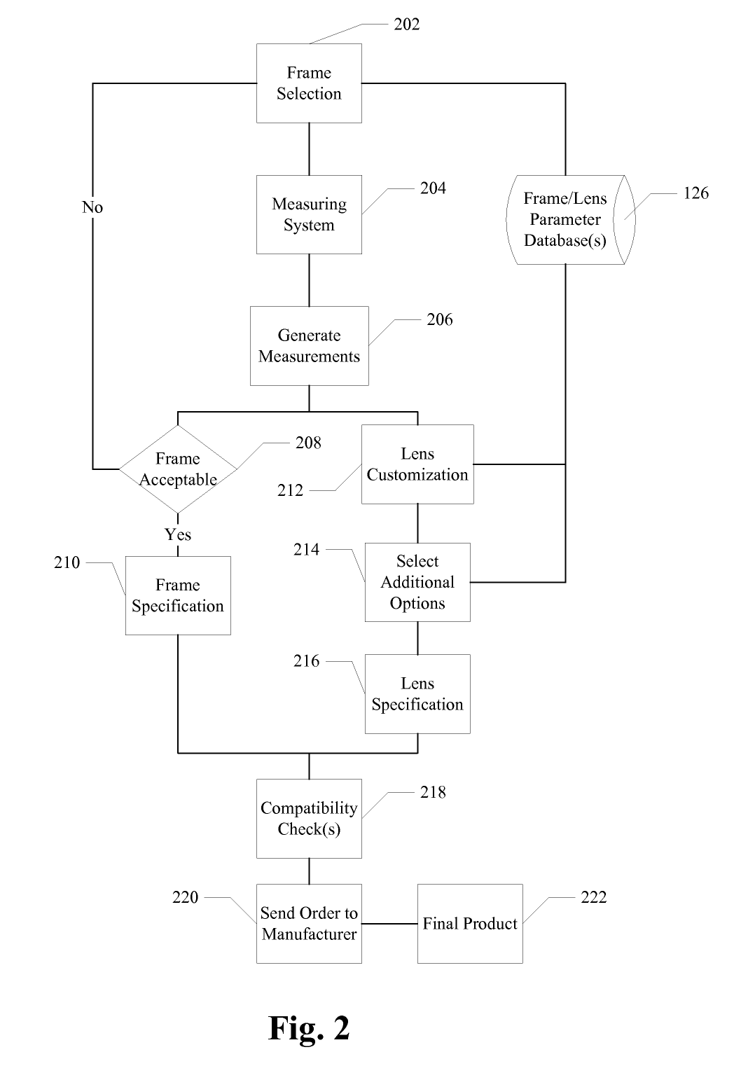

A flow diagram of an overview of the system according to an illustrative embodiment is described with reference to FIG. 2. As illustrated in FIG. 2, the patient makes a frame selection 202. The frame selection may be made on the client device 102 or input into the client device 102, for example, via the frame module 110. The client device 102 communicates with the frame and/or lens parameter database(s) 126 to obtain the parameters of the selected frame, for example, frame size, frame identifier, frame color, frame eye size, frame bridge size, temple length, frame type, frame edge type, frame box measurements, frame circumference, frame base curve, frame shape, and other information of the type.

A measuring system 204, may be used to capture one or more images of the patient with or without the patient wearing the selected frame. The measuring system 204 may be the client device 102 including the optical and image acquisition technology and measurement data module 112, manual measurements, or the digital measuring device or system as described above. The measuring system 204 generates measurement data based on the images collected or receives measurement input data from the ECP or other digital measuring device or system 206. As described above, the measurement data may include, but are not limited to, the patient's facial measurements, PD, vertex, pantoscopic tilt (panto), frame wrap, segment height, optical center height, and other measurements of the type. The measurement data may be generated using facial recognition technology, digital measuring technologies that utilize a sensor attached to the patient's frames, and/or other digital measuring technologies of the type.

The measurement data is used to determine whether the selected frame fits the patient correctly 208, by comparing, for example, the patient's facial measurements or parameters to the parameters of the selected frame. This determination may be made by the client device 102. If the selected frame does not or will not fit the patient properly, the patient may select a different frame. The client device 102 may also recommend certain frame options to the patient based on the patient's facial measurements and the parameters of a variety of frames. If the selected frame does or will fit the patient properly, a frame specification may be created, including the parameters of the selected frame 210.

The measurement data is also used in determining the appropriate lenses for the patient. A patient may choose to have customized lenses. During lens customization 212, the client device 102 may retrieve the patient's prescription and other ECP recommendation information, for example, lens material, single vision lenses, bifocal lenses, multifocal lenses, progressive lenses, and other information of the type. The measurement data is used to determine the placement of the patient's prescription with the lenses based upon the frame selected by the patient. The ECP or patient may also select or input one or more additional options into the client device 102 to add to the patient's customized lenses, for example, anti-reflective coating, tint, and other features of the type 214.

In the lens customization 212, and the selection of additional options 214, the client device 102 may access the frame and/or lens parameter database(s) 126 to obtain the parameters of the customized lenses and a lens specification may be created, including the parameters of the customized lenses 216.

The frame specification 210 and the lens specification 216, are used to conduct one or more compatibility checks 218, to ensure the selected frame, customized lens, and coating combination can be manufactured. To run the compatibility check(s), the client device 102 may access one or more of the frame/lens cut-out module 114, the frame/lens compatibility module 116, and coating compatibility module 118. The modules 114-116 compare the parameters of the selected frames and the parameters of the customized lenses and make a determination as to whether the selected frame, customized lens, and coating can be combined for the patient. If the selected frame, customized lenses, and coating are not compatible the patient may select a different frame or alternative lenses. If the selected frame and customized lenses are compatible an order may be placed for the selected frame and customized lens combination 220. The client device 102 may transmit the order directly to the manufacturer or laboratory and a final product may be created including the selected frame and customized lens combination 222.

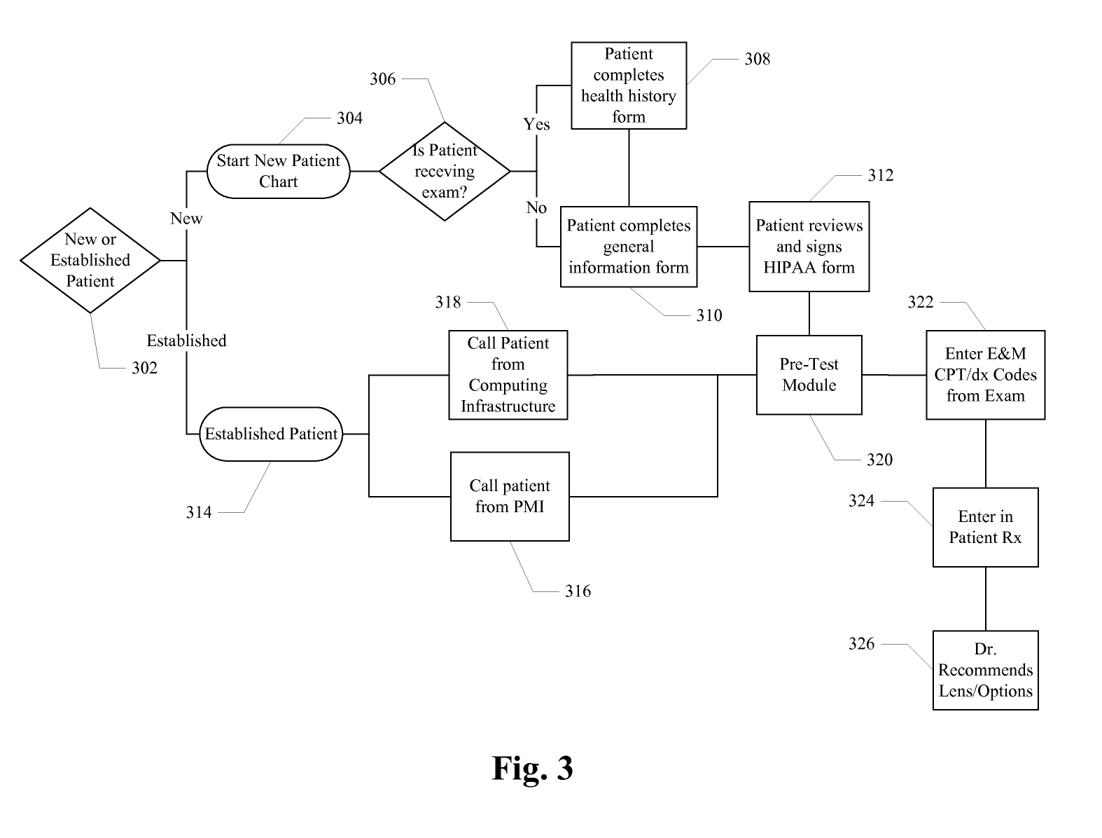

In an illustrative embodiment, the client device 102 may be used during a patient consultation. A functional block diagram for using the system for automated optical dispensing for a patient consultation according to an illustrative embodiment is described with reference to FIG. 3. The patient may consult an ECP for an eye examination and/or to purchase prescription lenses, frames, and other vision or optical devices, for example, eyeglasses and contact lenses. Initially, a determination as to whether the patient is a new patient or an existing patient is made. The client device 102 may prompt the user 104 of the client device 102, for example, the ECP, to identify whether the patient is a new patient or an existing patient 302. If the patient is a new patient, the client device 102 may perform a new patient intake function 304 and prompt the user 104 to identify whether the new patient is receiving an examination 306, or simply purchasing an optical device.

If the new patient is receiving an examination, the client device 102 may display a patient history form on the client device 102 for the new patient to fill out on the client device 102, 308. After the patient history form is complete, the client device may display a general information form on the client device 102 for the new patient to fill out on the client device 102, 310. If the new patient is not receiving an examination the new patient may not need to fill out the patient history form and the client device may skip step 308 and proceed directly to displaying the general information form for the new patient to fill out on the client device 102, 310. After the general information form is complete, the client device 102 may display a Health Insurance Portability and Accountability Act (HIPAA) form on the client device 102 for the new patient to electronically sign via the client device 312.

If the patient is an existing patient, the client device 102 may perform an established patient function 314. The client device 102 may retrieve the existing patient's information 316, including, but not limited to, health information and/or benefits information from the ECP's PMI 106 from the computing infrastructure 108, or from an insurance provider via the computing infrastructure 108, illustrated as 318.

For the existing patient or the new patient, upon completion of the forms, the ECP may optionally perform one or more pre-tests, for example, but not limited to, reading the new patient's or existing patient's prescription using an autorefractor and performing one or more visual field tests with the new patient or existing patient 320. In an illustrative embodiment, the client device 102 may be integrated with the pre-test systems or machines and automatically receive the data or results produced by the pre-test systems or machines, which the client device 102 may store in the database(s) 124. In another illustrative embodiment, the ECP may manually input the data or results produced by the pre-test systems or machines in to the client device 102.

The ECP may then input or select the evaluation and management (E&M) codes, current procedural terminology (CPT) codes, and diagnosis (dx) codes related to the examination performed into or via the client device 102, illustrated as 322. E&M codes generally identify the medical billing process that practicing ECPs in the United States use. CPT codes generally describe medical, surgical, and diagnostic services performed by the ECP. Diagnosis (dx) codes generally identify the ECP's diagnosis, for example, prescription information, near sighted, far sighted, and other diagnoses of the type. The ECP may then input the new patient's or existing patient's prescription into or select the prescription on the client device 102, illustrated as 324. Upon completion of the examination and determination of the new patient's or existing patient's prescription, the ECP may recommend certain lens and/or frame options 326, and record the recommendations using the client device 102.

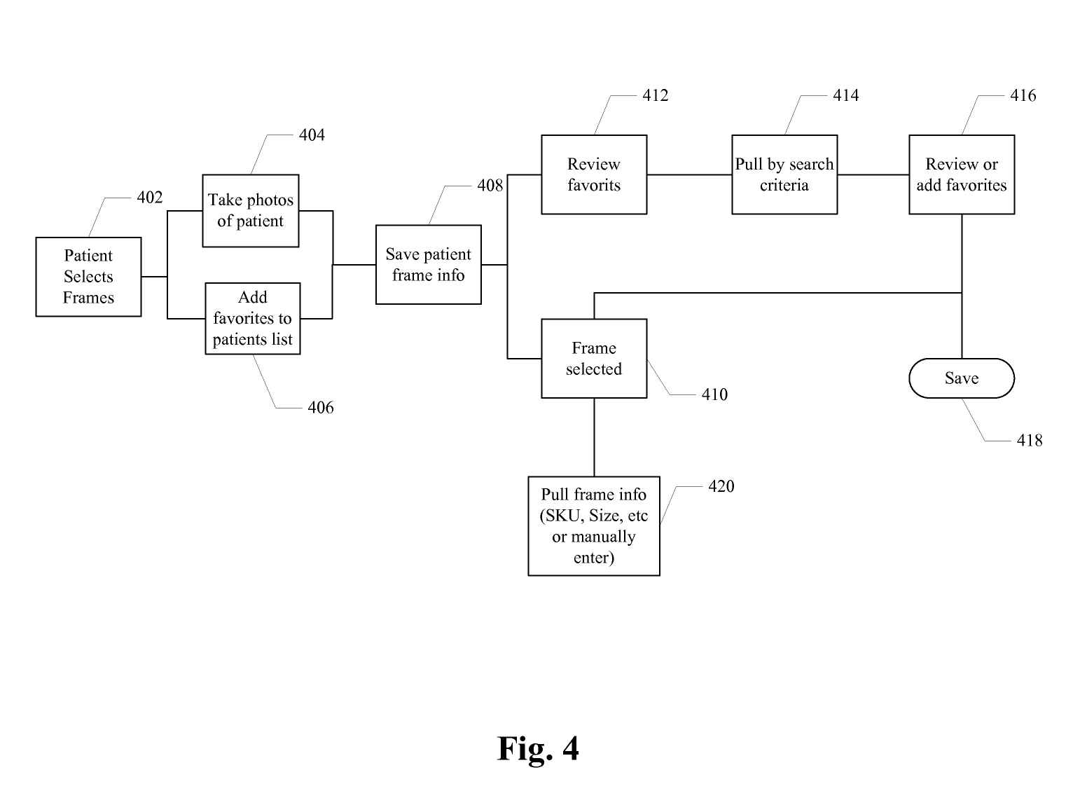

The client device 102 may also be used by the ECP and/or patient to evaluate and select frame options. A functional block diagram for using the system for evaluating frame options according to an illustrative embodiment is described with reference to FIG. 4. As illustrated in FIG. 4, the patient may select one or more frames or frame styles 402. The ECP or patient may use the client device 102 to collect one or more images of the patient wearing the selected frame(s) 404. Alternatively or additionally, the ECP or patient may input the selected frame(s) information into or select the selected frame(s) information on the client device 102, illustrated as 406. The client device 102 may then communicate with the frame module 110 and transmit the image(s) and/or selected frame information to the frame module 110. The frame module 110 stores the image(s) and/or selected frame information in the database(s) 124, illustrated as 408. The frame module 110 may store the image(s) and/or selected frame information in a patient favorites file allowing the patient image(s) and/or selected frame information to be retrieved.

The ECP or the patient may select the frame that the patient desires 310, or review the patient image(s) and/or selected frame information stored in the database(s) 124, illustrated as 412, via the client device 102. If the ECP or patient reviews the patient image(s) and/or selected frame information, the client device 102 may retrieve the patient image(s) and/or selected frame information from the database(s) 124 via the frame module 110 and display the patient image(s) and/or selected frame information to the ECP or patient on the client device 102.

The ECP or patient may retrieve the patient image(s) and/or selected frame information or search for additional frame options using search criteria 414. The client device 102 may present the ECP or patient with a search input and the ECP or patient may input a search query to search for frame options. The client device 102 communicates the search query to the frame module 110, which searches one or more databases in communication with the computing infrastructure 108, for example, the frame and lens database(s) 126, for frames satisfying the search query. The frame module 110 transmits the search results to the client device 120.

The client device 102 may then display the frames satisfying the search query to the ECP or patient. The ECP or patient can review the frame options on the client device 102 and/or add one or more of the frame options to the patient favorites file 416. As described above, the client device 102 communicates with the frame module 110 to save the added frame option(s) in the database(s) 124, illustrated as 418.

Once the patient selects a frame 410, the client device 102 may communicate the selection to the frame module 110. The frame module 110 may retrieve the information related to the selected frame from one or more databases in communication with the computing infrastructure 108, for example, the frame and lens database(s) 126, illustrated as 420, and transmit the frame information to the client device 102 and/or store the frame information in the database(s) 124. The frame information retrieved may include, but is not limited to, a stock-keeping unit (SKU), frame size, frame identifier, frame color, frame eye size, frame bridge size, temple length, frame type, frame edge type, frame box measurements, frame circumference, frame base curve, frame shape, frame material, frame manufacturer, frame collection, lens shape, and other information of the type. In another illustrative embodiment, the ECP may manually input the frame information into the client device 102.

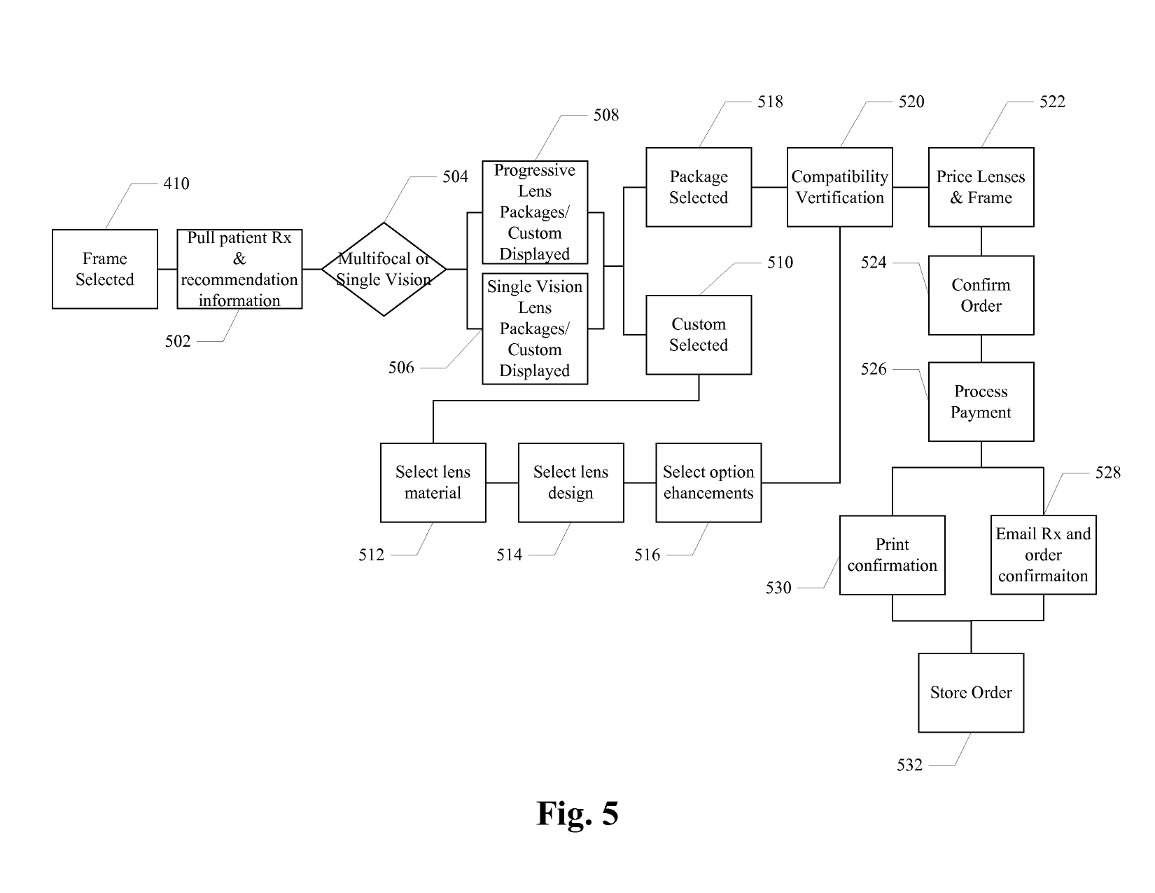

The client device 102 may also be used by the ECP and/or patient to evaluate and select lens options and to ensure the lenses are compatible with the selected frames. A functional block diagram for using the system for evaluating lens options and ensuring compatibility according to an illustrative embodiment is described with reference to FIG. 5. As illustrated in FIG. 5, once the patient selects a frame 410, the ECP may use the client device 102 to retrieve the patient's prescription and other ECP recommendation information from a local database or from the patient file or history stored in the database(s) 124 or the PMI 106, illustrated as 502. Based on the patient's prescription and the ECP recommendations, the ECP may use the client device 102 to select or input multifocal lenses or single vision lenses for the patient 504. Upon selection of single vision lenses, the client device 102 may display one or more single vision lens packages and/or custom single lens options, for the ECP or patient to choose from 506. Similarly, upon selection of multifocal lenses, the client device 102 may display one or more multifocal lens and progressive lens packages and/or custom multifocal lens and progressive lens options, for the ECP or patient to choose from 508.

Upon selection of the custom option 510, custom options, including lenses, are tailored to the patient's prescription and frame selection. Lens materials vary in thickness and clarity, by taking the patient's prescription and frame selection as factors the client device 102 recommends packages of lens materials and coatings to the ECP or patient. The client device 102 may prompt or allow the ECP or patient to select or input a lens material 512, for best optics and a cosmetically appealing lens, and a lens design 514, based on the patient's visual needs. The client device 102 also allows the ECP or patient to select or input one or more additional features, for example, anti-reflective coating, tint, and other features of the type 516. The client device 102 may also use the measurement data, described above, to determine the placement of the patient's prescription with the lenses selected based upon the frame selected by the patient.

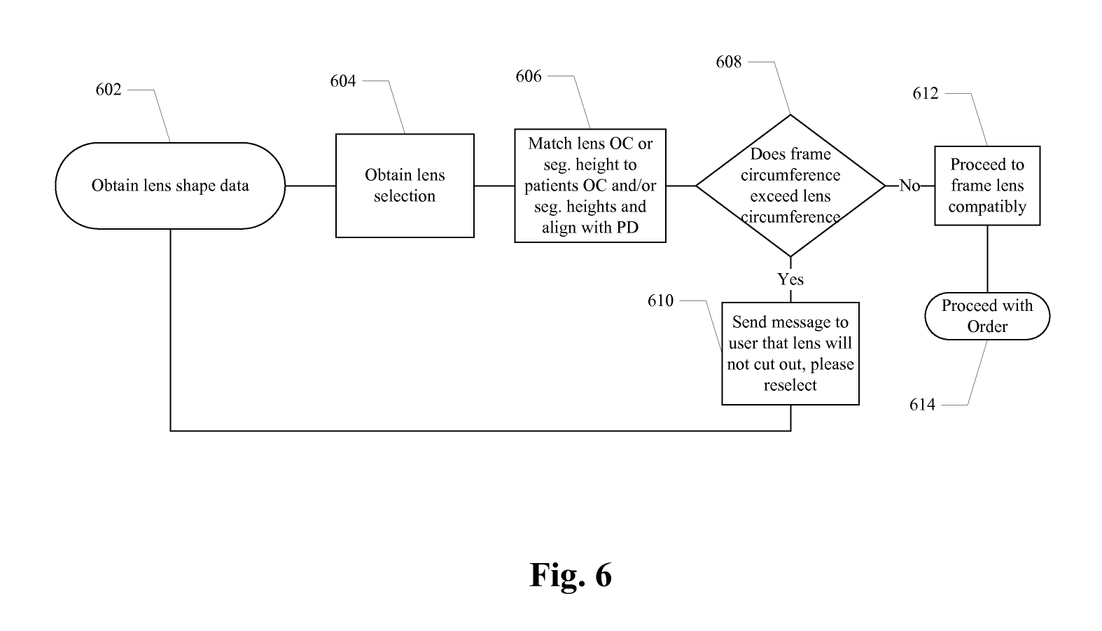

Once the custom process is complete, illustrated as steps 510-516, or a package is selected 518, one or more compatibility checks may be executed 520, to ensure the lenses, frame, and coating options selected can actually be constructed or manufactured. The compatibility checks are described in further detail below, with reference to FIGS. 6-10. If the compatibility checks result in an incompatible determination, the client device 102 may prompt the ECP or patient to select one or more of a different frame, lens, and coating. When the compatibility checks result in a compatible determination, the ECP may use the client device 102 to price the selected lenses and frame 522. In pricing the selected lenses and frame, the client device 102 may communicate with the computing infrastructure 108 to retrieve and apply the patient's insurance benefits, the usual and customary price versus the amount the insurance benefits cover versus the amount the patient may have to pay.

The ECP may review the price with the patient and if the patient is satisfied or wishes to proceed, the ECP may use the client device 102 to confirm the order 524. The client device 102 may optionally be used to process any payment by the patient, for example, via credit card, debit card, and/or electronic check 526.

The client device 102 may then communicate with the computing infrastructure 108 and transmit the order to the claim processing centers 130 or manufacturer or laboratory 132, illustrated as 528. Optionally, the client device 102 may produce and transmit packaging slips 530. Once the order has been sent, the client device 102 communicates with the computing infrastructure 108 and stores the order in the database(s) 124, illustrated as 532.

A functional block diagram of the frame/lens cut-out module according to an illustrative embodiment is described with reference to FIG. 6. As described above, the client device 102 is configured to receive a prescription, lens type or selection, and/or frame selection and access the frame/lens cut-out module 114. The frame/lens cut-out module 114 obtains lens shape data 602. The lens shape data 602 may be obtained from the frame and/or lens parameter database(s) 126, an image of the patient from the measurement data module 112, and/or based on the frame data of the frame selected by the patient. The lens shape data 602 may include the shape of the selected frame the lenses are to be inserted into, for example, a circumference of the selected frame, including a horizontal measurement of the selected frame or eyesize of the selected frame (A measurement), a vertical measurement of the selected frame or frame depth (B measurement), an effective diameter (ED) of the selected frame that defines the minimum diameter lens that fits the frame when the geometric center of the lens is centered in the frame, and/or other information of the type.

The frame/lens cut-out module 114 obtains or receives the lens selection 604, for example, via the frame module 110, client device 102, a manual input from the ECP, or other device such as the Optikam system referenced hereinbefore. The frame/lens cut-out module 114 may also obtain lens data from the frame and/or lens parameter database(s) 126 related to the lens selection, for example, a circumference of the lens selection, an optical center (OC) of the lens selection, segment heights of the lens selection, and/or other information of the type. The frame/lens cut-out module 114 then matches the OC of the lens selection and/or the segment heights of the lens selection to the patient's OC and/or the patient's segment heights and aligns the lens with the patient's interpupillary distance (PD) 606. The matching 606 may also be performed by the client device 102, manually by the ECP, or other device in communication with the client device 102. It should be appreciated that the patient's OC, segment heights, and PD may be obtained via the optical and imaging technology, client device 102, a manual input from the ECP, and/or the measurement data module 112.

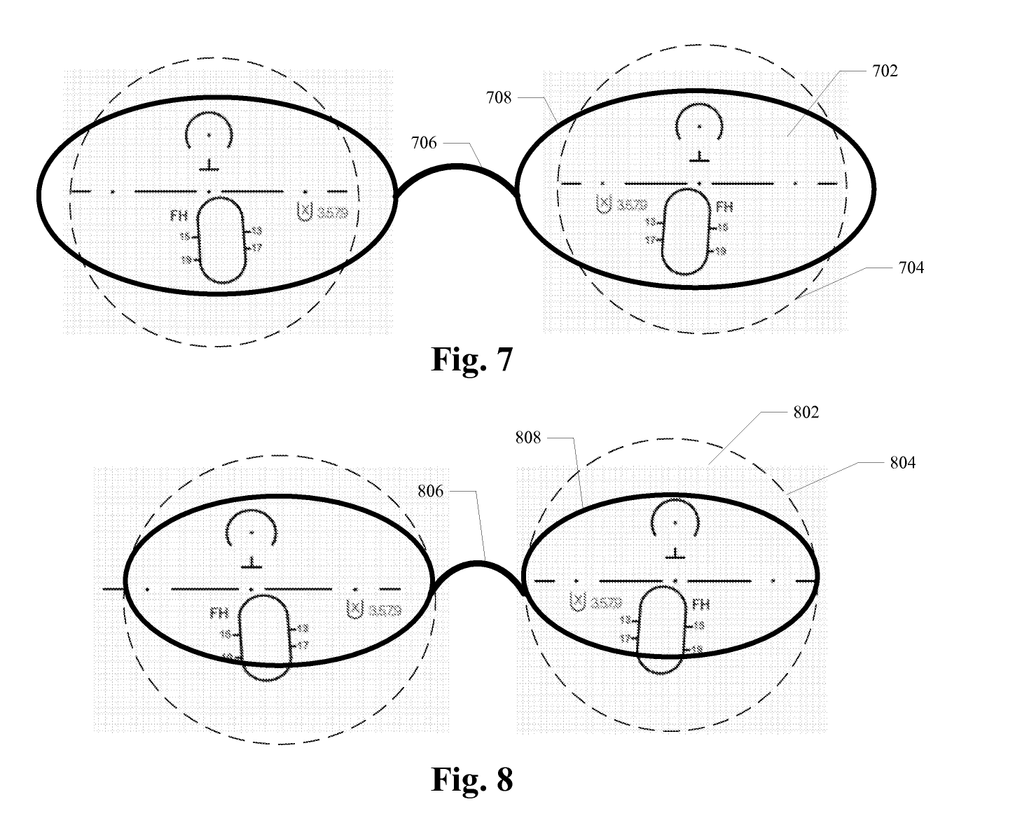

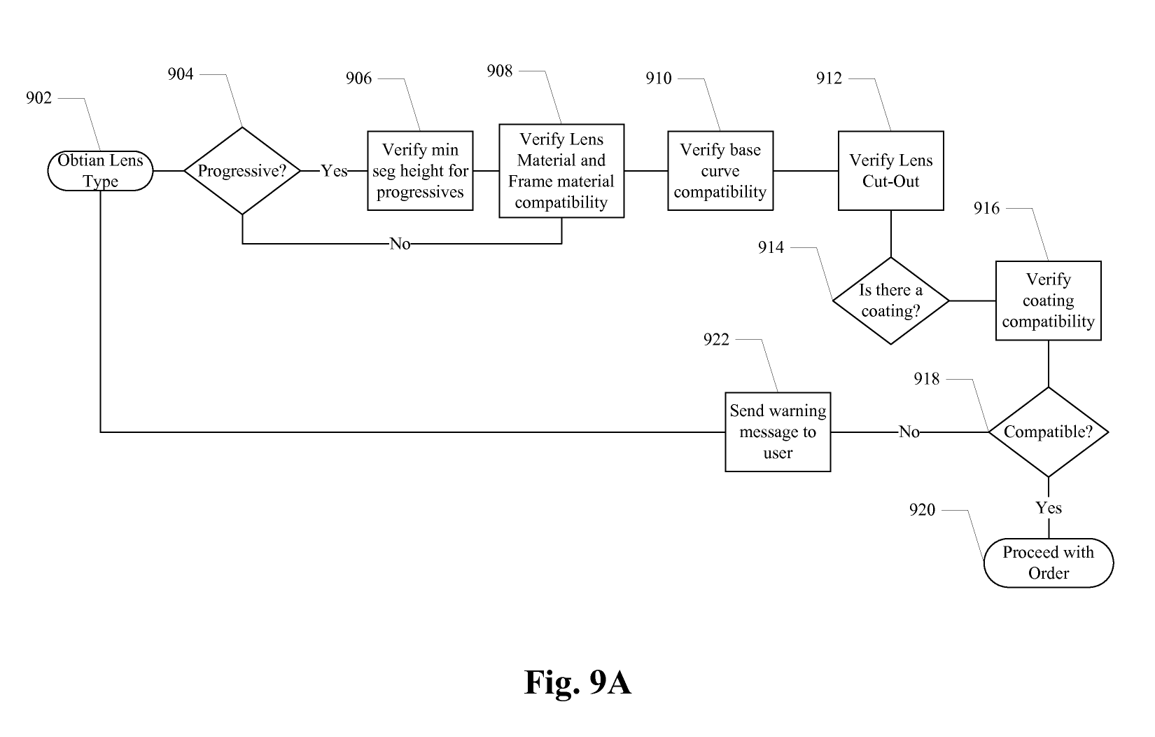

The frame/lens cut-out module 114 determines whether the circumference of the selected frame selection exceeds the circumference of the lens selection 608. An example of the circumference of the selected frame exceeding the circumference of the lens selection is illustrated in FIG. 7. As illustrated in FIG. 7, a lens 702 has a circumference 704 and a frame 706 has an eyepiece having a circumference 708. The circumference 704 of the lens 702 is smaller than the circumference 708 of the frame 706. In this example the lens 702 will not cut out properly for the frame 706. An example of the circumference of the selected frame matching the circumference of the lens selection is illustrated in FIG. 8. As illustrated in FIG. 8, a lens 802 has a circumference 804 and a frame 806 has an eyepiece having a circumference 808. In this example the circumference 804 of the lens 802 matches the circumference 808 of the frame 806, and the lens 802 will cut out properly for the frame 806.

Referring back to FIG. 6, when the circumference of the selected frame exceeds the circumference of the lens selection, the frame/lens cut-out module 114 sends a message to the user or patient, via the client device 102, that the lens selection will not cut out properly for the selected frame 610. The frame/lens cut-out module 114 may also prompt the user or patient to re-select a lens selection or frame selection, via the client device 102, and the process may be repeated. When the circumference of the selected frame does not exceed the circumference of the lens selection, the frame/lens cut-out module 114 may proceed to the frame/lens compatibility module 116, illustrated as 612, and proceed with the order 614.

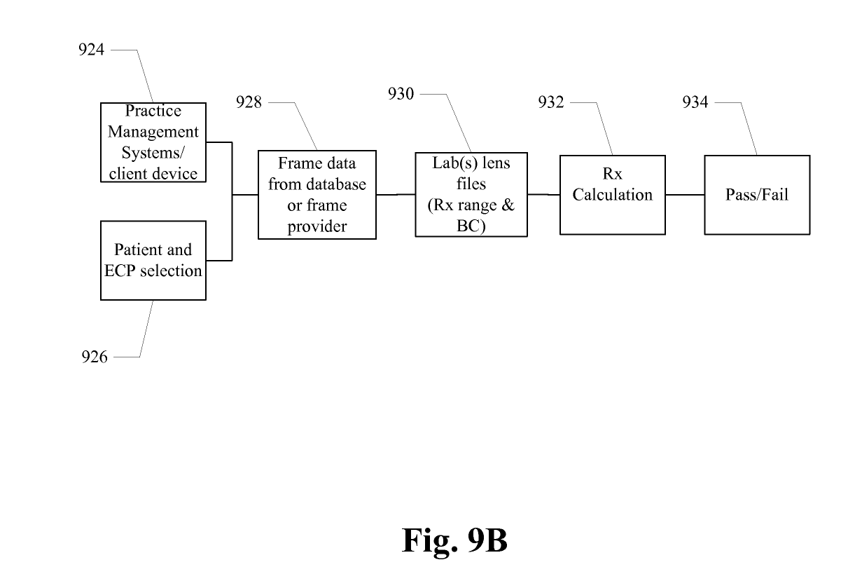

A functional flow diagram of the frame/lens compatibility module according to an illustrative embodiment is described with reference to FIG. 9A. As described above, the frame/lens compatibility module 116 receives the lens type or lens selection and the frame selection and communicates with and retrieves data from the frame and/or lens parameter database(s) 126. The frame/lens compatibility module 116 determines or obtains the lens type 902, based on the lens selection. The frame/lens compatibility module 116 determines whether the lens type is a progressive lens 904. If the lens type is a progressive lens, the frame/lens compatibility module 116 verifies the minimum segment height for the progressive lens 906. In verifying the minimum segment height, the frame/lens compatibility module 116 may communicate with the frame and/or lens parameter database(s) 126 to obtain the minimum segment height for the progressive lens.

The frame/lens compatibility module 116 may then verify the lens material and frame material compatibility 908. In verifying the material compatibility, the frame/lens compatibility module 116 may communicate with the frame and/or lens parameter database(s) 126 to obtain the material for the lens selection and the frame selection. When the lens type is not a progressive lens, the frame/lens compatibility module 116 may skip the step illustrated as 906 and proceed directly to verifying the material compatibility, illustrated as 908. The frame/lens compatibility module 116 also verifies a base curve compatibility of the lens selection and the frame selection 910. In verifying the base curve compatibility, the frame/lens compatibility module 116 may communicate with the frame and/or lens parameter database(s) 126 to obtain the base curve information for the lens selection and the frame selection.

A flow diagram of the verification of the lens material and frame material compatibility 908 and the base curve compatibility 910 according to an illustrative embodiment is described with reference to FIG. 9B. As illustrated in FIG. 9B, the frame selection and/or lens selection may be received by the client device 102 by a Practice Management System (PMS) 924 and/or input by the patient of ECP as a patient and ECP selection 926. The client device 102 may obtain frame data for the frame selection from a frame database or a frame provider 928. The frame database or frame provider 928 may be the frame and/or lens parameter database(s) 126, such as, for example, a database provided by Eyefinity of Rancho Cordova, Calif.; Jobson Healthcare Information (JHI) of New York, N.Y.; Digital Vision Incorporated (DVI) of Portland, Oreg.; and/or other databases of the type.

The frame data that is typically obtained includes, but is not limited to, the frame material, A measurement, B measurement, ED, frame base curve, and frame circumference. Lens files 930 are also accessed, for example, lens files or data from a lens provider or laboratory, such as laboratories of or affiliated with Vision Service Plan of Sacramento, Calif., and other laboratories. The lens files 930 may provide lens front curve data, product prescription ranges, and frame base curve (BC) tolerances. This data may be used to determine whether the frame BC tolerance is within a certain range based on the lens data.

Basic Rx prescription calculations 932 are performed using the patient's prescription, lens material, frame shape and size as well as other default materials to optimize the prescription. For example, the prescription calculations 932 calculate lens thickness and incorporate frame measurements, lens material, base/front curve, edge thickness, patient measurement data (for example PD, vertex, panto, and frame wrap), and any coatings.

In general, the pantoscopic tilt refers to the frame angle going up and down the lenses when viewing a frame from the side. Normally a frame will have a pantoscopic tilt of about 7-12 degrees towards the patient's cheek, this angle of tilt seeks to maximize the reading power on spectacle lenses. Vertex distance measures the distance between the back of the lenses to the front of the patient's eye. The average vertex distance is about 14 mm. If the vertex distance is further away or closer to the eye the effective power of the lenses can be altered. Frame wrap is a measurement of the frames wrap angle (average is about 5 degrees). In an ideal situation the frame wrap angle follows the natural front curve of the patient's head. The frame wrap can impact the patients peripheral view. By incorporating each of these measurements into the prescription calculations 932 for each patient, the patient's lens selection and frame selection can be made to optimize the patients viewing experience.

In one example, the prescription calculations 932 may be performed using information/data or products from Digital Vision Incorporated (DVI) of Portland, Oreg. The results of the calculations 932 identify whether the selected frame and lens selection combination pass or fail 934. When the selected frame and lens selection fail, the frame/lens compatibility module 116 may send a message to the user or patient via the client device 102 and prompt the user or patient to re-select a lens selection or frame selection. When the selected frame and lens selection pass, the frame/lens compatibility module 116 continues.

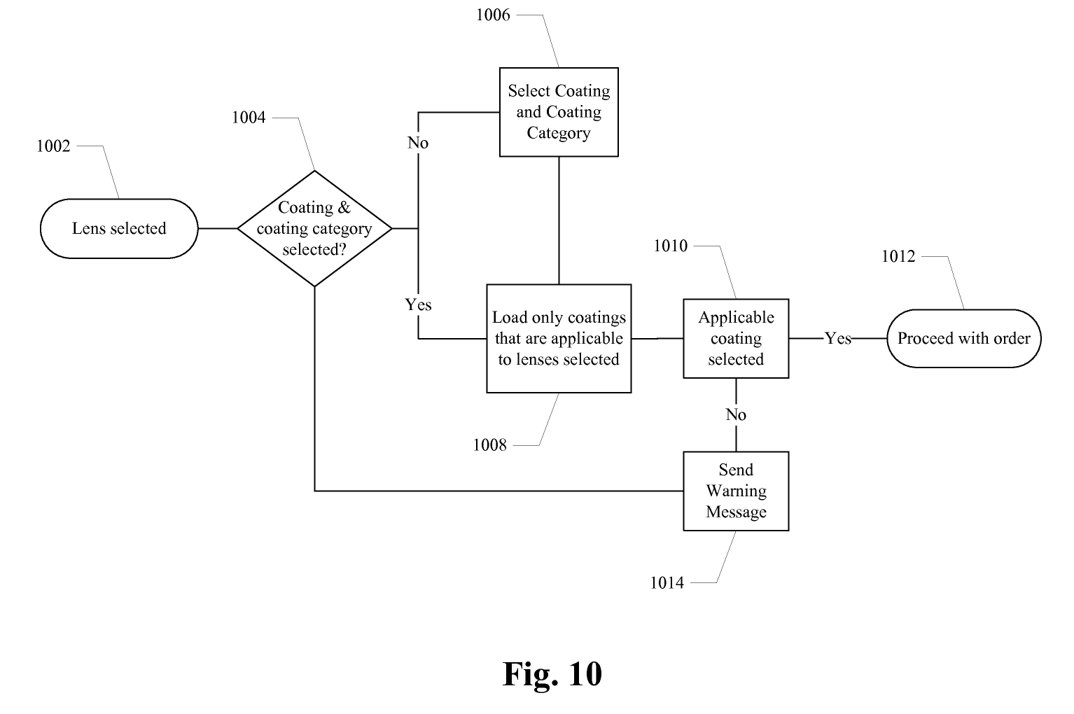

Referring back to FIG. 9A, the frame/lens compatibility module 116 verifies the lens cut-out 912, as described above with reference to FIGS. 6-10. The frame/lens compatibility module 116 determines whether a coating has been selected 914. If a coating has been selected the frame/lens compatibility module 116 verifies the coating compatibility 916, the coating verification is described in further detail below with reference to FIG. 10. Based on the verification and determination steps, the frame/lens compatibility module 116 determines whether the frame selection and the lens selection are compatible 918. When the frame/lens compatibility module 116 determines the frame selection and the lens selection are compatible, the frame/lens compatibility module 116 allows the user or patient to proceed or the client device 102 proceeds with the order 920.

When the frame/lens compatibility module 116 determines the frame selection and the lens selection are incompatible, the frame/lens compatibility module 116 sends a warning message to the user or patient via the client device 102, illustrated as 922. The message may include a prompt to the user or patient to re-select a lens selection or frame selection, via the client device 102, and the process may be repeated.

It should be appreciated that the frame/lens compatibility module 116 may terminate the compatibility process at any point along the process when an incompatible parameter is determined and send the message to the user or patient that the frame selection and the lens selection are incompatible. Further, it should be appreciated that the steps of the compatibility process may be performed in any order.

A functional flow diagram of the coating compatibility module according to an illustrative embodiment is described with reference to FIG. 10. As illustrated in FIG. 10, the coating compatibility module 118 receives a lens selection 1002. The lens selection may be received from the user or patient via the client device 102. The coating compatibility module 118 determines whether a coating and/or coating category has been selected 1004. If no coating and/or coating category has been selected, the coating compatibility module 118 may prompt the user or patient to select a coating and/or coating category if desired 1006. Once the coating and/or coating category is selected or if the coating and/or coating category was already selected, the coating compatibility module 118 may obtain or load only the coatings that are applicable to the lens selection 1008. The coatings that are applicable to the lens selection may be obtained or loaded from the coating parameter database(s) 128.

The coating compatibility module 118 then determines whether the selected coating and/or coating category is an applicable coating based on the lens selection 1010. When the coating compatibility module 118 determines the lens selection and the selected coating and/or coating category are compatible, the coating compatibility module 118 allows the user or patient to proceed or the client device 102 proceeds with the order 1012.

When the coating compatibility module 118 determines the lens selection and the selected coating and/or coating category are incompatible, the coating compatibility module 118 sends a warning message to the user or patient via the client device 102, illustrated as 1014. The message may include a prompt to the user or patient to re-select a lens selection or coating and/or coating category, via the client device 102, and the process may be repeated.

In an illustrative embodiment the client device 102 may include security features to prevent unauthorized users from using the client device 102. The client device 102 may require a user name and password, and/or other personal identification information, which can be used to identify and/or authenticate the user 104.

In an illustrative embodiment, the client device(s) 102 may be continually or periodically connected to the computing infrastructure 108 or separate/disconnected from the computing infrastructure 108. The client device 102 may be a mobile electronic communication device such as but not limited to a computer, a tablet computer, a smart phone, a personal digital assistant (PDA), and other mobile devices that can access, provide, transmit, receive, and modify information over wired or wireless networks and that contains the optical and image acquisition technology described above. The network may be a local area network or a wide area network and may be a private or public network of any size or scope. In an illustrative embodiment, the network is the Internet. Although the modules 110-122 are described as being in the computing infrastructure 108, the modules 110-122 may be included within the client device 102 or different modules may be distributed between the computing infrastructure and client device.

In an illustrative embodiment, the client device 102 may receive or collect the input data from the user 104 through the use of a client/user interface or graphical user interface, for example, an interface installed on the client device 102, an application, and/or a remotely accessible interface. The user interface may include visual, audio, graphics, charts, and other features of the type. The user interface may include one or more menus incorporating a number of specific questions, prompts, selection boxes, fillable fields, or any combination thereof that the user may answer, select, or input data into, for example by typed, stylus/touch-screen, oral, and/or written.

While the systems and methods have been described and illustrated in connection with certain embodiments, many variations and modifications will be evident to those skilled in the art and may be made without departing from the spirit and scope of the disclosure. The disclosure is thus not to be limited to the precise details of methodology or construction set forth above as such variations and modification are intended to be included within the scope of the disclosure. Moreover, unless specifically stated any use of the terms first, second, etc. do not denote any order or importance, but rather the terms first, second, etc. are merely used to distinguish one element from another.

What is claimed is:

1. A method for automated optical dispensing implemented in a computer network, comprising:
receiving, by said computer network, a frame selection and a lens selection;
obtaining, by a measurement data module in said computer network, measurements based on an image of a patient;
determining, by said measurement data module in said computer network, a position of a prescription within said lens selection based on said frame selection and said measurements;
running, by a compatibility module in said computer network, a compatibility verification on said frame selection and said lens selection;
determining, by said compatibility module in said computer network, whether said frame selection and said lens selection are compatible; and
transmitting, via said computer network, an order to a manufacturer for said frame selection and said lens selection when said frame selection and said lens selection are compatible.

2. The method according to claim 1, wherein said obtaining said measurements includes obtaining, by said measurement data module in said computer network, said measurements based on an image of a patient wearing said frame selection.

3. The method according to claim 1, wherein said obtaining said measurements includes obtaining, by said measurement data module in said computer network, said measurements including at least one of a facial measurement of said patient, a pupillary distance (PD), a vertex, a pantoscopic tilt (panto), a frame wrap, a segment height, an optical center height, and a facial shape of said patient,

4. The method according to claim 1, further comprising obtaining, by said compatibility module in said computer network, parameters associated with said frame selection and said lens selection from a database.

5. The method according to claim 1, further comprising receiving, by a frame/lens cut-out module in said computer network, said frame selection and said lens selection.

6. The method according to claim 5, further comprising obtaining, by said frame/lens cut-out module in said computer network, lens shape data associated with said lens selection.

7. The method according to claim 6, further comprising determining, by said frame/lens cut-out module in said computer network, whether a circumference of said frame selection exceeds a circumference of said lens selection.

8. The method according to claim 1, further comprising receiving, by a coating compatibility module in said computer network, a coating selection.

9. The method according to claim 8, further comprising obtaining, by said coating compatibility module in said computer network, a list of coatings that are applicable to said lens selection.

10. The method according to claim 9, further comprising determining, by said coating compatibility module in said computer network, whether said coating selection is within said list of coatings.

11. A system for automated optical dispensing, comprising:
a mobile client device configured to receive a frame selection and a lens selection;
an optical and imaging technology integrated with said mobile client device, said optical and imaging technology configured to collect images of a patient;
said mobile client device configured to access a measurement data module configured to determine a position of a prescription within said lens selection based on said frame selection and said images; and
said mobile client device configured to access a compatibility module configured to receive said frame selection and said lens selection and determine whether said frame selection and said lens selection are compatible;
said mobile client device configured to submit an order to a manufacturer for said frame selection and said lens selection when said frame selection and said lens selection are compatible.

12. The system of claim 11, wherein said mobile client device is integrated with an existing practice management system, practice management software, or practice management interface.

13. The system of claim 11, wherein said mobile client device is configured to access a frame/lens cut-out module configured to determine whether said lens selection will cut out for said frame selection.

14. The system of claim 11, wherein said mobile client device is further configured to receive a coating selection.

15. The system of claim 14, wherein said mobile client device is configured to access a coating compatibility module configured to receive said lens selection and said coating selection and determine whether said coating selection and said lens selection are compatible.

16. The system of claim 15, wherein said coating compatibility module is configured to access a coating database.

17. The system of claim 11, wherein said mobile client device is configured to access a frame parameter database and a lens parameter database.

18. A method for automated optical dispensing, comprising:
receiving, by a mobile client device, a first frame selection from a patient;
receiving, by said mobile client device, a first lens selection from said patient;
accessing, by said mobile client device, a compatibility module configured to run a compatibility verification on said first frame selection and said first lens selection;
receiving, by said mobile client device, a determination from said compatibility module whether said first frame selection and said first lens selection are compatible; and
prompting, by said mobile client device, said patient to select a second frame selection when said first frame selection and said first lens selection are incompatible.

19. The method of claim 18, further comprising:
receiving, by said mobile client device, said second frame selection from said patient;
accessing, by said mobile client device, said compatibility module configured to run said compatibility verification on said second frame selection and said first lens selection; and
receiving, by said mobile client device, a determination from said compatibility module whether said second frame selection and said first lens selection are compatible.

20. The method of claim 19, further comprising submitting, by said mobile client device, an order to a manufacturer for said second frame selection and said first lens selection when said second frame selection and said first lens selection are compatible.
